(19) United States
(12) Patent Application Publication
(10) Pub. No.: US 2025/0300921 A1
(43) Pub. Date: Sep. 25, 2025

(54) MONITORING METHOD FOR AN INDUSTRIAL NETWORK

(71) Applicant: Beckhoff Automation GmbH, Verl (DE)

(72) Inventors: Martin Rostan, Nürnberg (DE); Thomas Rettig, Rheda-Wiedenbrück (DE)

(21) Appl. No.: 19/230,196

(22) Filed: Jun. 6, 2025

Related U.S. Application Data
(63) Continuation of application No. PCT/EP2023/086161, filed on Dec. 15, 2023.

(30) Foreign Application Priority Data
Dec. 22, 2022 (DE) 10 2022 134 520.3

(51) Int. Cl. H04L 43/16; H04L 9/40; H04L 41/12

(52) U.S. Cl. CPC H04L 43/16; H04L 41/12; H04L 63/20

(57) ABSTRACT

In order to detect a change in a topology of an industrial network which comprises an arrangement of network nodes connected to one another, at least one network node determines the runtime of a message in the industrial network. If the determined runtime or a runtime change exceeds a predefined threshold value, this is evaluated as an indication of a network node that has been subsequently inserted into the network topology and a security mode is activated.

### CROSS-REFERENCE TO RELATED APPLICATIONS

This application is a continuation of International Patent Application No. PCT/EP2023/086161, filed Dec. 15, 2023, entitled “Monitoring Method for an Industrial Network,” which claims the priority of German patent application DE 10 2022 134 520.3, filed 22 Dec. 2022, entitled “Überwachungsverfahren für ein industrielles Netzwerk,” each of which is incorporated by reference herein, in the entirety and for all purposes.

### FIELD

The invention relates to a method for detecting a change in the topology of an industrial network.

### BACKGROUND

In industrial networks, network nodes that are added subsequently without the knowledge of the network management represent a potential cyber security threat. For example, network nodes added at a later point in time could be used to falsify or disrupt data traffic. It is thus necessary to reliably detect whether additional network nodes have been added after the network configuration has been completed. This applies both to an ongoing operation and to an operational pause during which the industrial network is switched off.

### SUMMARY

The invention provides improved protection against a subsequently added network node in an industrial network.

According to an aspect, a method for detecting a change in a topology of an industrial network consists of an arrangement of network nodes which are connected to one another, wherein at least one network node determines the runtimes of messages in the industrial network, wherein, if the determined runtime or a runtime change exceeds a predetermined threshold value, this is evaluated as an indication of a network node subsequently inserted into the network topology and a security mode is activated.

According to a further aspect, a method for detecting a change in a topology of an industrial network consists of an arrangement of network nodes which are connected to one another, wherein a plurality of network nodes determines the runtimes of messages in the industrial network by measuring the time between transmitting a message and the return of the message, the plurality of which being determined depending on the operational conditions of the network, wherein, if the determined propagation time or a propagation time change exceeds a predetermined threshold value, this is evaluated as an indication of a network node subsequently inserted into the network topology and a security mode is activated.

### EXAMPLES

In a method for detecting a change in a topology of an industrial network which consists of an arrangement of network nodes that are connected to one another, the runtime of messages in the industrial network is determined by at least one network node. If the determined runtime or a runtime change exceeds a predefined threshold value, this is evaluated as an indication of a network node that has been subsequently inserted into the network topology and a security mode is activated.

With the aid of runtime monitoring in the industrial network, a subsequently added network node may be reliably detected and a corresponding protective measure may be initiated by activating a safety mode.

A runtime monitoring network node may be provided, which reads out the determined runtime from the network node and determines whether the read-out runtime exceeds the specified threshold value. The runtime monitoring network node is preferably a control node in the industrial network, which determines a data transfer in the industrial network.

The monitoring of cyber security threats in the industrial network may thus be carried out centrally and adapted to the respective network embodiment via the runtime monitoring network node.

It is furthermore possible for a plurality of network nodes to carry out runtime measurements and for the runtime monitoring network node to correlate the runtime measurements of the individual network nodes in order to create a runtime matrix. The runtime monitoring network node may recognize whether and where one or a plurality of additional network nodes have been inserted by evaluating the runtime matrix generated in this manner.

The security mode may include a warning information that may be acknowledged in order to terminate the security mode.

This ensures that the operator is informed about the status of the cyber security threat in the industrial network and that an incorrect security mode activation may be deactivated again, for example if an intended change to the network topology is deemed to be the subsequent insertion of a network node.

The threshold value may be correlated with an environmental parameter, in particular the ambient temperature. The threshold value may also be correlated with an operating parameter, in particular an operating time.

By correlating the threshold value with the environmental or operating parameters of the industrial network, the reliability of cyber security threat monitoring in the industrial network may be increased. In particular, it may be ensured that the number of incorrect security mode activations is reduced.

The network node for determining the runtime may be a first network node that measures the runtime of the messages to a connected second network node using Precision Time Protocol.

This procedure may be used to continuously determine the runtime between two neighboring network nodes. Changes in the determined runtime caused by changing environmental influences, in particular ambient and component temperature, generally remain below the threshold value, which ensures reliable monitoring.

In order to determine the runtime, the network node may also measure the time between transmission of a message and the return of the message.

The network node that measures the time between the transmission of a message and the return of the message may be the first network node after the control node in the network topology.

Furthermore, a plurality of network nodes may each measure the time between the transmission of a message and the return of the message, the number being determined depending on the operating conditions of the industrial network.

In industrial networks in which the messages sent are processed by the network nodes on the fly, this allows for simplified time measurement, which may be optimally adapted to the respective network topology.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a schematic depiction of an Ethernet-based industrial network 1; and

FIG. 2 shows a method for measuring the runtime between two network nodes in the industrial network shown in FIG. 1.

### DETAILED DESCRIPTION

In manufacturing and process automation, industrial networks are used in which the decentralized devices of a machine periphery such as I/O modules, transmitters, drives, valves, and operator terminals communicate with automation, engineering, or visualization systems via a powerful communication system.

The active subscribers in industrial networks are the automation, engineering or visualization systems, which are referred to as control nodes in the following. They usually have network access authorization, send the control or output data and monitor the data transfer in the industrial network and the network status. The peripheral machine devices are the recipients of the control data in the industrial networks and are referred to below as network nodes. They acknowledge received messages and send messages with sensor and status data, also referred to as input data, either independently or at the request of a control node.

Industrial networks with a wide variety of transmission specifications are used in automation technology. In cyclical industrial networks, the data is transmitted regularly and continuously, regardless of whether a change to the data has taken place. In acyclic industrial networks, on the other hand, the data is only transmitted if a change to the data has taken place or if the control node explicitly triggers the data transmission.

A distinction is also made between station-oriented industrial networks, in which a control node sends a message to a network node, which the network node then acknowledges or responds to, and message-oriented industrial networks, which are characterized by the fact that the control node issues unconfirmed messages that may then be processed by all network nodes. Furthermore, bus-oriented industrial networks are used in which the control node transmits all data for all connected network nodes in one message, wherein the location of the data for the respective network node is determined by its position in the message block.

As the network connection in an industrial environment often takes place from device to device in a sequence, industrial networks are often implemented as a ring of network nodes starting from a control node. Industrial networks generally have a bidirectional connection structure between the network nodes, i.e. data transmission between two network nodes is possible in both directions.

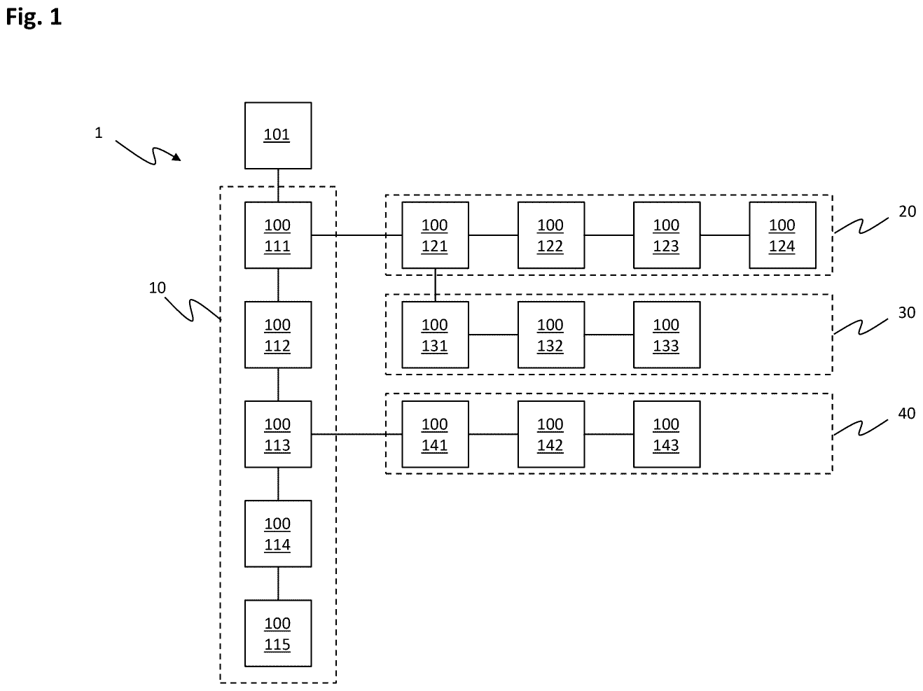

FIG. 1 shows a schematic depiction of an Ethernet-based industrial network 1 as an example. The industrial network 1 is divided up into a plurality of segments and comprises a first segment 10, a second segment 20, a third segment 30 and a fourth segment 40. Each segment comprises a plurality of network nodes 100.

The first segment 10 comprises a first network node 111, a second network node 112, a third network node 113, a fourth network node 114 and a fifth network node 115.

The second segment 20 has a sixth network node 121, a seventh network node 122, an eighth network node 123 and a ninth network node 124.

The third segment 30 comprises a tenth network node 131, an eleventh network node 132 and a twelfth network node 133.

The fourth segment 40 comprises a thirteenth network node 141, a fourteenth network node 142 and a fifteenth network node 143.

The network nodes in the various segments are each connected to one another via a bidirectional connection structure. The network nodes each comprise at least two interfaces, also known as ports, which are each embodied as a combined data input and data output, also known as a transceiver.

The first network node 111 of the first segment 10 is also embodied as a first network distributor and connects the first segment 10 to the second segment 20. For this purpose, the first network node 111 comprises an additional third interface, which connects the first network node 111 of the first segment 10 to the sixth network node 121 of the second segment 20.

The third network node 113 of the first segment 10 is embodied as a second network distributor, which connects the third network node 113 of the first segment 10 to the thirteenth network node 141 of the fourth segment 40 via an additional third interface.

The sixth network node 121 of the second segment 20 is embodied as a third network distributor. The third network distributor comprises a further third interface via which a connection is established between the sixth network node 121 of the second segment 20 and the tenth network node 131 of the third segment 30.

The network 1 shown in FIG. 1 therefore comprises a structure in which the second segment 20 and the fourth segment 40 are coupled to the first segment 10 and are therefore arranged downstream of the first segment 10. The third segment 30 is coupled to the second segment 20 and is therefore arranged downstream of the second segment 20.

In addition to the network nodes 100 arranged in the segments, the industrial network 1 comprises a control node 101, which is connected upstream of the segments and is connected to the first network node 111 of the first segment 10, which is embodied as the first network distributor.

A uniform transmission rate may be used throughout the industrial network. However, the network nodes 100 in the various segments may also communicate with each other at different transmission rates.

In industrial networks, the network topology, i.e. the physical sequence and arrangement of the network nodes in the network, is determined using a configuration tool either manually by selecting the network nodes from a list and then inserting them at the relevant position or automatically by scanning the existing network. Once the network topology has been determined, the application-specific parameters of the respective network nodes are configured, the process data, i.e. the input and output data, are defined and linked to the process variables of the control node and the query frequency or cycle time is set.

Network nodes that are subsequently added to the industrial network without the knowledge of the network management represent a potential cyber security threat. The subsequently added network nodes could, for example, be used to falsify or disrupt data traffic. It is therefore necessary to reliably detect whether additional network nodes have been added after the network configuration has been completed. This applies both to ongoing operation and to an operational pause during which the industrial network is switched off.

A change in the network topology may be detected by a network node determining the runtimes of messages in the industrial network, wherein, if the determined runtime or a runtime change exceeds a predefined threshold value, this is evaluated as an indication of an additional network node inserted into the network topology and a security mode is activated.

The security mode may, for example, be a modified data traffic, such as a restricted process data exchange, in order to prevent the process data from being corrupted. The security mode may also include warning information to the operator, which may be acknowledged by the operator in order to terminate the security mode if, for example, the operator determines that no additional network node has been undesirably inserted and that it was therefore a false alarm.

In many industrial networks, a message usually sent as an Ethernet frame (in accordance with IEEE 802.3) by the control node is first received by each network node and then interpreted. The message is then forwarded by the network node.

In such industrial networks, runtime measurement may be carried out using time stamps in the messages exchanged between the network nodes. The time of an event is used as a time stamp by hardware-implemented readout of a high-resolution system clock in the network node at the time of the event. In order to determine the runtime of a message between a network node and a neighboring network node, the time stamp of sent and incoming messages is evaluated in the network nodes. The Precision Time Protocol (PTP) defined in the IEEE 1588 or IEC 61588 standard and the IEEE P802.1AS-Rev protocol derived from it in Time-Sensitive Networking (TSN) and its further development are used for this purpose.

Two procedures are possible for the runtime measurement. If the network node is able to send messages exactly at a predefined time using suitable hardware and software, the transmission time may be sent as a time stamp in the respective message. Otherwise, the actual transmission time of the network node is recorded by a transmission time stamp temporarily stored in the network node. The transmission timestamp temporarily stored in the network node is then sent by the network node in a subsequent message.

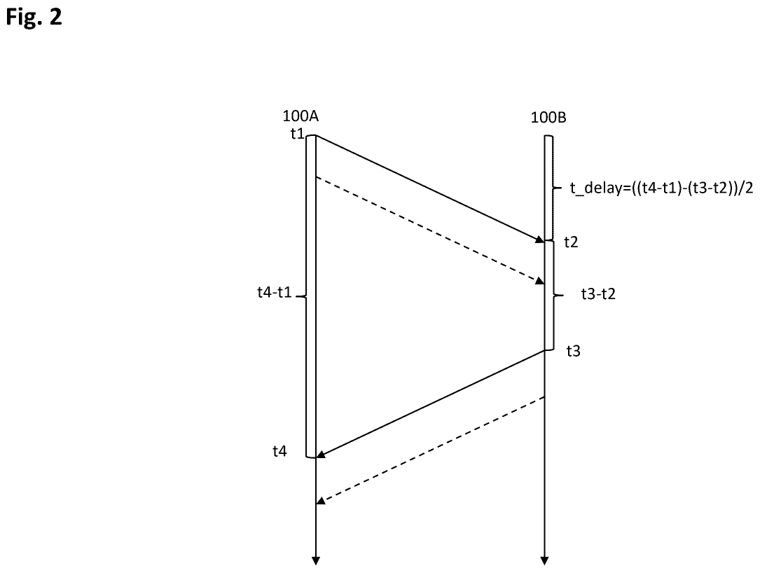

FIG. 2 shows a runtime measurement between a first network node 100A and a second network node 100B in the industrial network 1 shown in FIG. 1. The network nodes are embodied in such a way that a message is first received by each network node, then interpreted and then sent on.

The first network node 100A sends a first message N1 to the second network node 100B at a first transmission time t1, the second network node 100B receiving the first message at a second receiving time t2. The first transmission time t1 and the second receiving time t2 are recorded by a corresponding first transmission timestamp in the first network node 100A and a second receiving timestamp in the second network node 100B.

In response, the second network node 100B then sends a second message N2 back to the first network node 100A at a third transmission time t3, the first network node 100A receiving the second message N2 at the fourth receiving time t4. The third transmission time t3 and the fourth receiving time t4 are in turn recorded by a corresponding third transmission timestamp in the second network node 100B and fourth receiving timestamp in the first network node 100A.

The second network node 100B may transmit the second receiving time t2 and the third transmission time t3 or the second receiving time t2 and the time difference between the third transmission time t3 and the second receiving time t2 to the first network node 100A either with the second message itself or as an option, as indicated by the dashed line in FIG. 1, with a further message sent later.

The runtime t_delay between the first network node 100A and the second network node 100B is then determined by the first network node 100A as follows:

$$t\_delay = [ ( t 4 - t 1 ) - ( t 3 - t 2 ) ] / 2.$$

The runtime determination is based on the assumption that the forward path from the first network node 100A to the second network node 100B and the return path from the second network node 100B to the first network node 100A have the same average runtimes, which only change slowly. The runtime includes not only the runtime on the links between the first network node 100A and the second network node 100B, but also the delay in the transceivers of the two network nodes, which may be assumed to be constant.

An alternative way of determining the runtime is to use industrial networks in which the network nodes process the messages, which are usually sent as Ethernet frames (in accordance with IEEE 802.3), in a continuous process. The network node takes the output data intended for the respective network node from the received messages while the message passes through the network node. Input data is also inserted into the message by the network node as it passes through. The message is not received in full before the message is processed, but processing begins as soon as the control data in the message is received. Sending then also takes place with a minimum offset of a few bit times.

In such industrial networks, which are logically organized as a ring of network nodes, each network node that is not connected at the end of the bidirectional connection structure is passed through twice by the message.

In the industrial network 1 shown in FIG. 1, in which the first network node 111 of the first segment 10 is the first network distributor, the third network node 113 of the first segment 10 is the second network distributor and the sixth network node 121 of the second segment 20 is the third network distributor, so that the second segment 20 and the fourth segment 40 are coupled to the first segment 10 and are downstream of the first segment 10 and the third segment 30 is coupled to the second segment 20 and is downstream of the second segment 20, the following throughput sequence results for a message.

Starting from the control node 101, the message is transmitted to the first segment 10 to the first network node 111, then to the second segment 20 to the sixth network node 121, to the seventh network node 122, to the eighth network node 123, to the ninth network node 124, back to the eighth network node 123, to the seventh network node 122, to the sixth network node 121, into the third segment 30 to the tenth network node 131, to the eleventh network node 132, to the twelfth network node 133, back to the eleventh network node 132, to the tenth network node 131, to the sixth network node 121, to the first network node 111, then in the first segment 10 to the second network node 112, to the third network node 113, then into the fourth segment 40 to the thirteenth network node 141, to the fourteenth network node 142, to the fifteenth network node 143, back to the fourteenth network node 142, to the thirteenth network node 141, to the third network node 113, then on to the fourth network node 114, to the fifth network node 115, then back to the fourth network node 114, to the third network node 113, to the second network node 112, to the first network node 111, and then to the control node 101.

The individual network nodes generally have the functionality of measuring the time between an outgoing and returning message, hereinafter referred to as the return time, with high precision at each port. This may be done with the help of time stamps, which are assigned to the message in the network node when it is sent or received. The time of the transmission or receiving event is used as the time stamp by hardware-implemented reading of the high-resolution system clock in the network node at the respective event time.

In the industrial network shown in FIG. 1, the runtime measurement may be carried out in such a way that the network nodes 100 determine the return time of a special message sent by the control node 101 at all ports and enter it in memory registers in the network node that may be read by the control node. After the message has circulated through the segments, the control node 101 reads the receiving times or the return time from the memory registers of the network nodes with the aid of further messages and may determine the transit times between the individual network nodes 100 from this.

For example, if the seventh network node 122 in the second segment 20 in the industrial network 1 shown in FIG. 1 has determined a first receiving time t1 on the forward path and a fourth receiving time t4 on the return path and the eighth network node 123 in the second segment 20 has determined a second receiving time t2 on the forward path and a third receiving time t3 on the return path, the control node 101 then determines the delay time t_delay between the seventh network node 122 and the eighth network node 123 as follows:

$$t\_delay = [ ( t 4 - t 1 ) - ( t 3 - t 2 ) ] / 2.$$

The runtime determination is again based on the assumption that the forward path from the seventh network node 122 to the eighth network node 123 and the return path from the eighth network node 123 to the seventh network node 122 have the same average runtimes, which change only slowly. The runtime includes not only the runtime on the connecting routes between the seventh network node 122 and the eighth network node 123, but also the throughput delay in the two network nodes, which may, however, be assumed to be constant.

Since in the industrial network 1 shown in FIG. 1, as described above, the network nodes connected to a port of a network node are all passed through by the messages, the runtime measurement may be carried out in such a way that all network nodes determine the return time through all downstream network nodes.

The first network node 111 receives the message from the control node 101 at its first port and forwards it through its second port to the second segment 20, the message returning from the second segment 20 is forwarded to the first segment 10 at the third port of the first network node 111, and the message returning from the first segment 10 is forwarded back to the control node 101 through the first port.

The return time at the second port of the first network node 111 therefore corresponds to the runtime from the first network node 111 through the sixth network node 121, the seventh network node 122, the eighth network node 123, the ninth network node 124, the eighth network node 123, the seventh network node 122, the sixth network node 121, the tenth network node 131, the eleventh network node 132, the twelfth network node 133, the eleventh network node 132, the tenth network node 131, and the sixth network node 121.

The return time at the third port of the first network node 111 therefore corresponds to the runtime from the first network node 111 through the second network node 112, the third network node 113, the thirteenth network node 141, the fourteenth network node 142, the fifteenth network node 143, the fourteenth network node 142, the thirteenth network node 141, the third network node 113, the fourth network node 114, the fifth network node 115, the fourth network node 114, the third network node 113, and the second network node 112.

In industrial networks in which the message is processed on the fly, even across a plurality of network nodes, the runtime is purely a hardware property that depends on the length of the connection lines and the number and nature of the network nodes, but not on their specific task in the communication cycle. It is irrelevant for the runtime whether the network node only forwards the message or whether the network node processes the message, i.e. reads output data from the message or writes input data into the message.

A runtime monitoring network node may be provided in the industrial networks, which reads and stores the runtimes between the network nodes in the network from the respective network nodes that carry out the runtime measurements. The runtime monitoring network node may, for example, be the control node 101 of the industrial network 1 shown in FIG. 1.

If the runtime between two neighboring network nodes is determined continuously, changes in the determined runtime due to changing environmental influences, in particular ambient and component temperature, generally remain below the threshold value. A network node exchange, on the other hand, could lead to the threshold value being exceeded and thus to a warning. A network node replacement must therefore be acknowledged accordingly.

The threshold value may be defined in such a way that the threshold value corresponds to the expected propagation delay on the line between the two neighboring network nodes and the transceiver delay in the two network nodes added by a tolerance value that takes into account possible temperature-related and operational changes. An additional extension of the runtime due to message processing and transmission in a further network node subsequently inserted between the two network nodes, which is many times higher than the line runtime and transceiver delay, would always exceed such a threshold value and would therefore be detected.

In industrial networks, in which the runtimes are determined from the return time of the first network node downstream of the control node, it is not possible to draw direct conclusions about the exact number of network nodes in large networks with many network nodes due to component scattering and ageing processes of the connected network nodes. The runtime may also change during operation due to environmental influences, in particular the ambient and component temperature. In large networks with many network nodes, these system-related changes in the return time of the entire network are often larger than the influence of an additional, subsequently added network node.

A typical transmission delay for network nodes is in the range of 1000 ns to 1500 ns (forward and return direction), depending on the hardware version, and is subject to typical temperature-related changes in the range of 1-2%. The transit time on the line is approx. 5 to 6 ns/m depending on the cable design and does not change significantly with temperature.

For this reason, measurement by a single network node downstream of the control node is generally only sufficient in small industrial networks with few network nodes. In small networks of less than 20 nodes, for example, the change in return time due to changing environmental influences, such as cooling during breaks in operation, is small compared to the increase in runtime due to a subsequently added node. In this case, it is sufficient to monitor the return time at the output interface of the first network node after the control node.

In large industrial networks comprising more than 20 network nodes, for example, the return time must be monitored by a plurality of network nodes, for example by every twentieth network node in the industrial network.

The network distributors may be used as network nodes for determining the runtime. In the industrial network 1 shown in FIG. 1, in addition to the first network node 111 of the first segment 10 as the first network distributor, the third network node 113 of the first segment 10 may also be used as the second network distributor and the sixth network node 121 of the second segment 20 as the third network distributor for measuring the runtime of the respective segment messages.

With such an approach, it is possible to correlate the runtime measurements of the individual network distributors in order to create a runtime matrix. This may be carried out by the runtime monitoring network node, for example the control node, which reads the return times from the network nodes in the industrial network that carry out the time determination and forms the runtime matrix. The runtime monitoring network node may recognize whether and where one or a plurality of additional network nodes have been inserted by evaluating the runtime matrix generated in this way.

This may be done by comparing the calculated runtimes with threshold values that specify the maximum runtime value to be expected for the runtime section. It is also possible to compare runtime matrices generated in succession and to define maximum permissible changes in the runtime as the threshold value.

The number of network nodes that measure the time between the transmission of a message and the return of the message may be determined depending on the operating conditions of the network.

With this procedure, the addition of further network nodes at the end of a segment or at an unused interface of a network node may also be detected. However, this is less relevant because the addition is detected by the network node anyway by evaluating the connection status of the interface. In protected environments, deactivating the unused interfaces, for example by the network node itself or by the control node in the industrial network, may also effectively prevent a network node from being added inadvertently.

In order to achieve improved monitoring, the threshold value, the exceeding of which is evaluated as an indication of a network node subsequently inserted into the network topology, may be correlated with environmental parameters such as an ambient temperature and/or operating parameters such as an operating time of the industrial network. As described above, the transmission delays for network nodes and therefore the runtime are temperature-dependent. This also applies to the cable structure between the network nodes. A pause in operation may also lead to cooling, which then has an influence on the transit time measurement. False alarms may be prevented by correlating with the threshold value.

To improve monitoring, it is also possible to carry out a number of runtime measurements in order to determine an average runtime.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

What is claimed is:

1. A method for detecting a change in a topology of an industrial network comprising an arrangement of network nodes which are connected to one another, wherein:
at least one network node determines runtimes of messages in the industrial network, and
wherein, if the determined runtime or a runtime change exceeds a predetermined threshold value, this is evaluated as an indication of a network node subsequently inserted into the network topology and a security mode is activated.

2. The method according to claim 1, wherein a runtime monitoring network node reads out the determined runtime from the network node and determines whether the read-out runtime exceeds the predetermined threshold value.

3. The method according to claim 2, wherein the runtime monitoring network node is a control node in the industrial network that determines a data transfer in the industrial network.

4. The method according to claim 2, wherein a plurality of network nodes carry out runtime measurements and the runtime monitoring network node relates the runtime measurements of the individual network nodes to one another in order to create a runtime matrix and, by evaluating the runtime matrix, to recognize whether and where one or a plurality of additional network nodes have been inserted.

5. The method according to claim 1, wherein the safety mode comprises a warning information that is acknowledgeable in order to terminate the safety mode.

6. The method according to claim 1, wherein the threshold value is correlated with an ambient parameter, in particular the ambient temperature.

7. The method according to claim 1, wherein the threshold value is correlated with an operating parameter, in particular an operating time.

8. The method according to claim 1, wherein the network node for determining the runtime is a first network node which measures the runtime of the messages to a connected second network node using a precision time protocol.

9. The method according to claim 1, wherein the network node measures the time between the transmission of a message and the return of the message to determine the runtime.

10. The method according to claim 9, wherein the network node that measures the time between the sending of a message and the return of the message is the first network node after the control node in the network topology.

11. The method according to claim 9, wherein a plurality of network nodes each measure the time between the transmission of a message and the return of the message, the plurality being determined depending on the operating conditions of the network.

12. A method for detecting a change in a topology of an industrial network comprising an arrangement of network nodes which are connected to one another, wherein:
a plurality of network nodes determines runtimes of messages in the industrial network by measuring the time between transmitting a message and the return of the message, the plurality of which being determined depending on the operational conditions of the network, and
wherein, if the determined propagation time or a propagation time change exceeds a predetermined threshold value, this is evaluated as an indication of a network node subsequently inserted into the network topology and a security mode is activated.

13. The method according to claim 12, wherein a runtime monitoring network node reads out the determined runtime from the network node and determines whether the read-out runtime exceeds the predetermined threshold value.

14. The method according to claim 13, wherein the runtime monitoring network node is a control node in the industrial network that determines a data transfer in the industrial network.

15. The method according to claim 13, wherein a plurality of network nodes carry out runtime measurements and the runtime monitoring network node relates the runtime measurements of the individual network nodes to one another in order to create a runtime matrix and, by evaluating the runtime matrix, to recognize whether and where one or a plurality of additional network nodes have been inserted.

16. The method according to claim 12, wherein the safety mode comprises a warning information that is acknowledgeable in order to terminate the safety mode.

17. The method according to claim 12, wherein the threshold value is correlated with an ambient parameter, in particular the ambient temperature.

18. The method according to claim 12, wherein the threshold value is correlated with an operating parameter, in particular an operating time.

19. The method according to claim 12, wherein the network node for determining the propagation time is a first network node which measures the propagation time of the messages to a connected second network node using a precision time protocol.

20. The method according to claim 12, wherein a network node that measures the time between the sending of a message and the return of the message is the first network node after the control node in the network topology.
